(19) United States
(12) Patent Application Publication
(10) Pub. No.: US 2007/0138874 A1
(43) Pub. Date: Jun. 21, 2007

(54) THREE-STATE SWITCH FOR POWER SUPPLY CIRCUIT

(75) Inventor: Xiang-Jian Kong, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,565

(22) Filed: Aug. 23, 2006

(30) Foreign Application Priority Data
Dec. 16, 2005 (CN) 200510120692.4

(51) Int. Cl. H02B 1/24

(52) U.S. Cl. 307/116

(57) ABSTRACT

A three-state switch includes a first input terminal, a first output terminal, a second output terminal, a pole, a first throw, a second throw, and a third throw. The first input terminal is for receiving a first signal. The first output terminal is coupled to the first input terminal, and for outputting a second signal. The second output terminal is for outputting a third signal. The first throw is for contacting with the pole to have the three-state switch output the second signal, and not output the third signal. The second throw is for contacting with the pole to have the three-state switch not output the second signal and the third signal. The third throw is for contacting with the pole to have the three-state switch output the second signal and the third signal. When the pole is suspended, the first output terminal outputs the second signal.

### 1. FIELD OF THE INVENTION

The present invention generally relates to three-state switches, and more particularly to a three-state switch for a power supply circuit.

### 2. DESCRIPTION OF RELATED ART

Power supply circuits are widely used to supply power to loads in most electronic devices. A typical power supply circuit employs a two-state switch having “on” and “off” states to power on/off a load. When the switch is switched to the “on” state, the load receives power from the power supply circuit and starts working. When the switch is switched to the “off” state, the power supplied to the load is cut off.

However, along with development of the electronic devices, new functions of the electronic devices have been introduced continuously. Nowadays, electronic devices are desired to provide a “hold” state in which the electronic devices remain at a specific state (e.g. playing) that cannot be disturbed by pressing functional keys including a “forward” key and a “backward” key. Take a motion picture expert group audio layer 3 (mp3) music for example, when the mp3 music is playing, users want to hold the present playing state without interruption by intentionally or accidentally pressing buttons such as the “forward” button and the “backward” button.

In order to provide the extra “hold” state, a three-state switch has been adopted in the power supply circuit. The three-state switch has an “on” state, an “off” state, and a “hold” state. The “on” state and the “off” state of the three-state switch have similar functions with those of the two-state switch. When the three-state switch is shifted to the “hold” state from the “on” state, the three-state switch sends a holding signal to the load to hold a present working state of the load.

Referring to FIGS. 5 and 6, a traditional power supply circuit 11 supplies an operating voltage and a holding signal to a load 4. The power supply circuit 11 includes a direct current (DC) source 1, a three-state switch 2, and a regulator 3. The three-state switch 2 includes an input terminal 202, a first output terminal 204, and a second output terminal 206. The input terminal 202 is used for receiving a voltage from the DC source 1. The first output terminal 204 is used for outputting an operating voltage and a driving signal to the regulator 3. The second output terminal 206 is used for outputting a holding signal to the load 4.

The three-state switch 2 also includes a first throw 208, a second throw 210, a third throw 212, and a pole 214. The first throw 208 is coupled directly to the first output terminal 204 and further connected to the second output terminal 206 via a backward diode 222. The second throw 210 remains suspended. The third throw 212 is coupled to the second output terminal 206. The pole 214 is coupled to the input terminal 202.

When the pole 214 is in contact with the first throw 208, the three-state switch 2 is switched to an “on” state, and the first output terminal 204 outputs the operating voltage and the driving signal to the regulator 3 whilst the second output terminal 206 is disabled. When the pole 214 is in contact with the second throw 210, the three-state switch 2 is switched to an “off” state, and the first output terminal 204 and the second output terminal 206 are both disabled. When the pole 214 is in contact with the third throw 212, the first output terminal 204 is disabled whist the second output terminal 206 outputs the holding signal to the load 4.

However, when the pole 214 is shifted from the first throw 208 to the third throw 212, there is an instantaneous period during which the pole 214 is connected to neither the first, second, or third throw 210, 212, or 214. In the instantaneous period, the three-state switch 2 is in the “off” state and unwanted discontinuation of power to the load 4 may occur.

Therefore, a three-state switch for a power supply circuit is needed in the industry to address the aforementioned deficiencies and inadequacies.

### SUMMARY OF THE INVENTION

A three-state switch includes a first input terminal, a first output terminal, a second output terminal, a pole, a first throw, a second throw, and a third throw. The first input terminal is for receiving a first signal. The first output terminal is coupled to the first input terminal, and for outputting a second signal. The second output terminal is for outputting a third signal. The first throw is for contacting with the pole to have the three-state switch output the second signal, and not output the third signal. The second throw is for contacting with the pole to have the three-state switch not output the second signal and the third signal. The third throw is for contacting with the pole to have the three-state switch output the second signal and the third signal. When the pole is suspended, the first output terminal outputs the second signal.

Other systems, methods, features, and advantages of the present three-state switch and a power supply circuit using the same will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present three-state switch and a power supply circuit using the same can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a block diagram showing a power supply circuit and a load in accordance with a first exemplary embodiment, the power supply circuit including a three-state switch;

FIG. 2 is a circuit diagram of the three-state switch of FIG. 1;

FIG. 3 is a block diagram showing a power supply circuit and a load in accordance with a second exemplary embodiment, the power supply circuit including a three-state switch;

FIG. 4 is a circuit diagram of the three-state switch of FIG. 3;

FIG. 5 is a block diagram showing a traditional power supply circuit and a load, the traditional power supply circuit including a traditional three-state switch; and

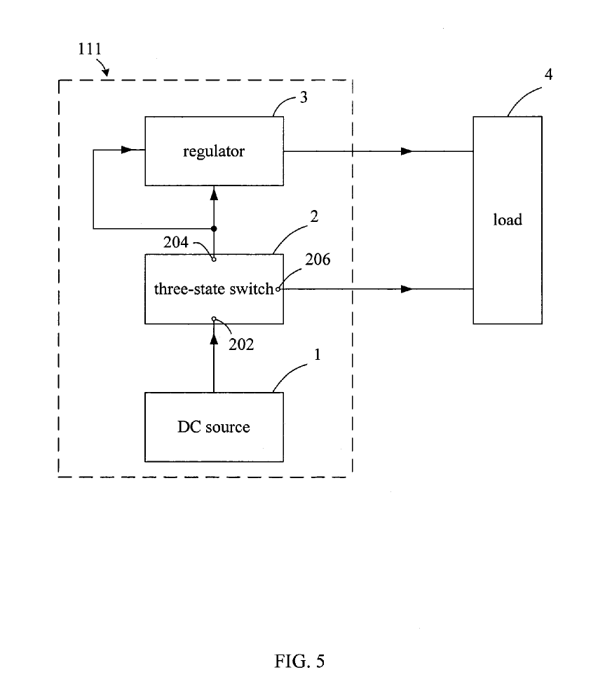

FIG. 6 is a circuit diagram of the three-state switch of FIG. 5.

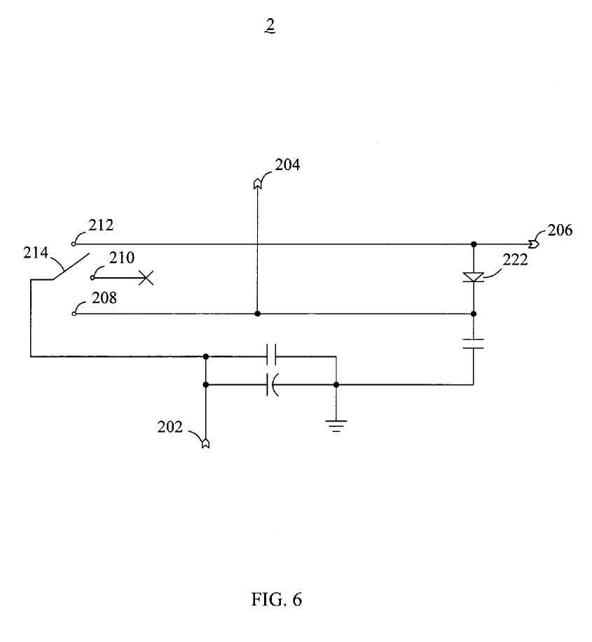

### DETAILED DESCRIPTION OF THE INVENTION

Reference will now be made to the drawings to describe preferred embodiments of the present power supply circuit and preferred embodiments of the present three-state switch.

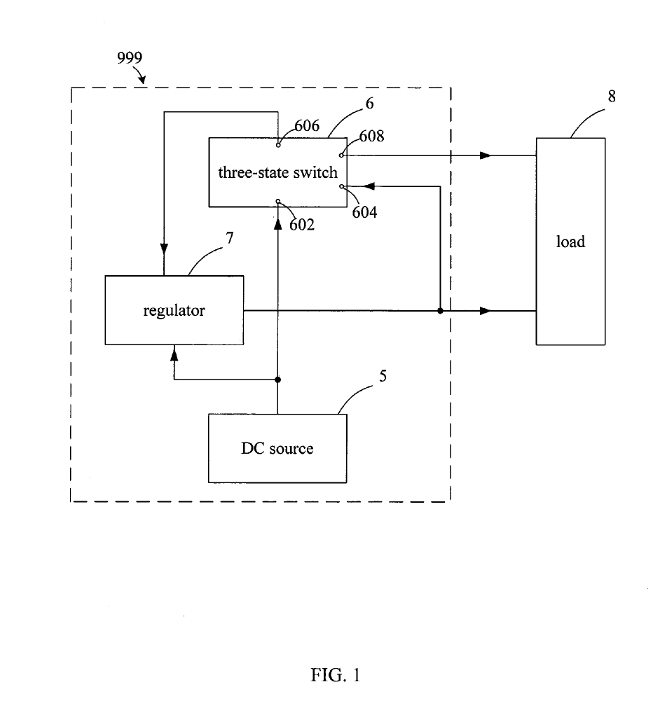

Referring to FIG. 1, a power supply circuit 999 in accordance with a first embodiment supplies an operating voltage and a holding signal to a load 8. The power supply circuit 999 includes a direct current (DC) source 5, a three-state switch 6, and a regulator 7. The DC source 5 is used for supplying an initial voltage to the three-state switch 6 and the regulator 7. The three-state switch 6 is used for outputting a driving signal to activate the regulator 7 after receiving the initial voltage from the DC source 5, and for outputting a holding signal to hold the load 8 present working state after receiving an output voltage from the regulator 7. The regulator 7 is used for receiving the initial voltage from the DC source 5 and the driving signal from the three-state switch 6, and outputting the output voltage to both the load 8 and the three-state switch 6.

The three-state switch 6 includes a first input terminal 602, a second input terminal 604, a first output terminal 606, and a second output terminal 608. The first input terminal 602 is coupled to the DC source 5 for receiving the initial voltage from the DC source 5. The second input terminal 604 is coupled to the regulator 7 for receiving the output voltage from the regulator 7. The first output terminal 606 is coupled to the regulator 7 for outputting the driving signal to the regulator 7. The second output terminal 608 is coupled to the load 8 for outputting the holding signal to the load 8.

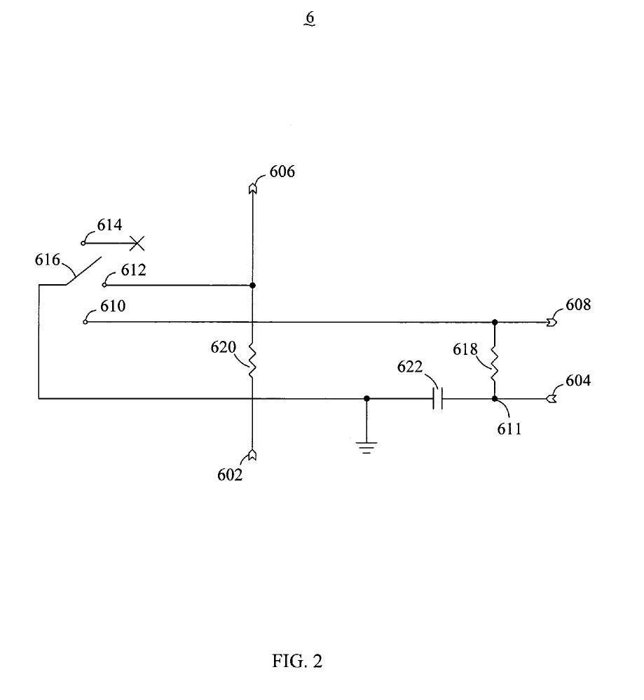

Referring also to FIG. 2, the three-state switch 6 also includes a first throw 610, a second throw 612, a third throw 614, and a pole 616. The first throw 610 is coupled to the second output terminal 608, and connected to a node 611 via a first resistor 618. The node 611 is connected to a virtual ground point via a capacitor 622, and the second input terminal 604. The second throw 612 is connected to the first input terminal 602 via a second resistor 620, and the first output terminal 606. The third throw 614 remains suspended. The pole 616 is coupled to the virtual ground point.

In an “on” state, the pole 616 is in contact with the first throw 610, and the node 611 is coupled to the virtual ground point. Herein, the initial voltage outputted from the DC source 5 is supplied to the first output terminal 606 via the first input terminal and the second resistor 620. Then, the first output terminal 606 outputs the initial voltage that is used as the driving signal of the regulator 7. The regulator 7 is activated by the driving signal to generate the output voltage based on the initial voltage from the DC source 5. The output voltage is supplied to the second input terminal 604 and the load 8. Because the first node 611 is coupled to the virtual ground point via the first throw 610 and the pole 616, the output voltage received from the regulator 7 is directed towards the virtual ground point instead of the second output terminal 608. Thus, the output terminal 608 is disabled and does not output the holding signal.

When the three-state switch 6 is shifted from the “on” state to a “hold” state, the pole 616 is shifted to be in contact with the third throw 614, the first throw 610 connected to the node 611 is suspended and the connection between the first node 611 and the virtual ground point is cut off. The output voltage outputted from the regulator 7 to the second input terminal 604 is directed towards the second output terminal 608 instead of the virtual ground point. The second output terminal 608 outputs the output voltage that is used as the holding signal of the load 8. Meanwhile, the initial voltage outputted from the DC source 5 is supplied to the regulator 7, and then the regulator 7 outputs the output voltage to the load 8. Based on the output voltage from the regulator 7 and the holding signal from the second output terminal 608 of the three-state switch 6, the load 8 is locked at the present working state.

When the three-state switch is shifted from the “hold” state to an “off” state, the pole 616 is shifted from the third throw 614 to be in contact with the second throw 612, and the first output terminal 606 is coupled to the virtual ground point. Therefore, the initial voltage outputted from the DC source 5 is directed towards the virtual ground point instead of the first output terminal 606 and the first output terminal 606 is disabled. That is, the driving signal supplied to the regulator 7 from the three-state switch 6 is cut off, thus, the regulator 7 is deactivated. Accordingly, the load 8 cannot receive the output voltage from the regulator 7.

During an instantaneous period in which the pole 616 is shifted from the first throw 610 to the third throw 614, the pole 614 is suspended and connected to none of the first, second, and third throw 610, 612, and 614. During the instantaneous period, the connection between the first input terminal 602 and the first output terminal 606 still exists, and the initial voltage outputted from the DC source 5 is supplied to the regulator 7 via the first output terminal 606. The regulator 7 outputs the output voltage to the load 8. Therefore, an unwanted power disruption of the present working state of the load 8 is avoided during the instantaneous period.

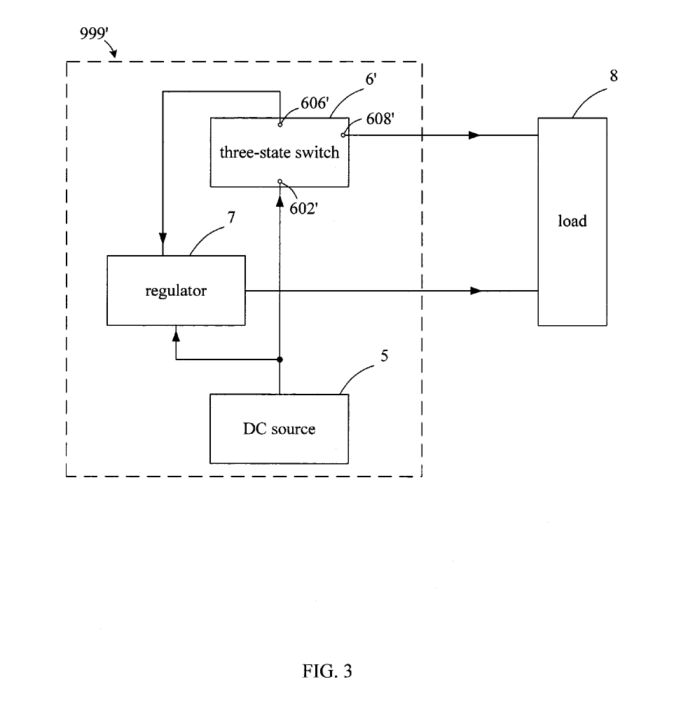

Referring to FIG. 3, a power supply circuit 999′ in accordance with a second embodiment supplies an operating voltage and a holding signal to a load 8. The power supply circuit 999′ includes a direct current (DC) source 5, a three-state switch 6′ and a regulator 7. The DC source 5 is used for supplying an initial voltage to the three-state switch 6′ and the regulator 7. The three-state switch 6′ is used for receiving the initial voltage from the DC source 5 and outputting a driving signal to the regulator 7 to activate the regulator 7 based on the initial voltage, and outputting the holding signal to the load 8 to hold a present working state of the load 8. The regulator 7 is used for receiving the initial voltage from the DC source 5 and the driving signal from the three-state switch 6′, and outputting the operating voltage to the load 8.

The three-state switch 6′ includes a first input terminal 602′, a first output terminal 606′, and a second output terminal 608. The first input terminal 602′ is coupled to the DC source 5 for receiving the initial voltage from the DC source 5. The first output terminal 606′ is coupled to the regulator 7 for outputting a driving signal to the regulator 7. The second output terminal 608 is coupled to the load 8 for outputting the holding signal to the load 8.

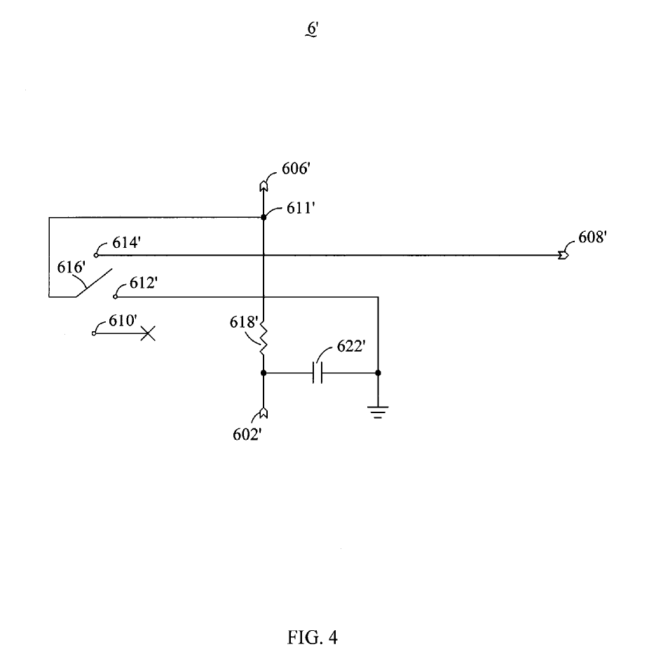

Referring also to FIG. 4, the three-state switch 6′ also includes a first throw 610′, a second throw 612′, a third throw 614′, and a pole 616′. The first throw 610′ remains suspended. The second throw 612′ is coupled to a virtual ground point. The third throw 614′ is coupled to the second output terminal 608. The pole 616′ is couple to a node 611′ that is connected to the first input terminal 602′ via a resistor 618, and to a first output terminal 606′. The first input terminal 602′ is connected to the virtual ground point via a capacitor 622′.

In an “on” state, the pole 616′ is in contact with the first throw 610′ that is suspended. The initial voltage outputted from the DC source 5 is supplied to the first output terminal 606′ via the first input terminal and the resistor 618. Then, the first output terminal 606′ outputs the initial voltage to serve as the driving signal to the regulator 7. The regulator 7 is activated by the driving signal to generate the output voltage based on the initial voltage from the DC source 5. The output voltage is supplied to the load 8. The load 8 starts working under the output voltage. Because the second output terminal 608 coupled to the third throw 614′ is suspended, the output terminal 608 is disabled and does not output the holding signal.

When the three-state switch 6′ is shifted from the “on” state to a “hold” state, the pole 616′ is shifted to be in contact with the third throw 614′. The second output terminal 608 is coupled to the first input terminal 602′ via the third throw 614′, the pole 616′, the node 611′, and the resistor 618. The second output terminal 608 outputs the initial voltage to serve as the holding signal to the load 8. Meanwhile, the initial voltage outputted from the DC source 5 is supplied to the regulator 7 and the regulator 7 outputs the output voltage to the load 8 to drive the load 8 to work. Based on the output voltage from the regulator 7 and the holding signal from the second output terminal 608 of the three-state switch 6′, the load 8 is locked at the present working state.

When the three-state switch is shifted from the “hold” state to an “off” state, the pole 616′ is shifted from the third throw 614′ to be in contact with the second throw 612′, and the node 611′ is coupled to the virtual ground point, the pole 616′, and the second throw 612′. Therefore, the initial voltage outputted from the DC source 5 is directed to the virtual ground point instead of the first output terminal 606′ and the first output terminal 606′ is disabled. That is, the driving signal supplied to the regulator 7 from the three-state switch 6′ is cut off, and the regulator 7 is deactivated and stops working. Accordingly, the load 8 cannot receive the output voltage from the regulator 7 and then stops working.

During an instantaneous period in which the pole 616′ is shifted from the first throw 610′ to the third throw 614′, the pole 614′ is suspended and connected to none of the first, second, and third throw 610′, 612′, and 614′. In this condition, the connection between the first input terminal 602′ and the first output terminal 606′ still exists, and the initial voltage outputted from the DC source 5 is supplied to the regulator 7 via the first output terminal 606′. The regulator outputs the output voltage to the load 8 to drive the load 8 to work. Therefore, unwanted break of the present working state of the load 8 is avoided during the instantaneous period.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A three-state switch comprising:
a first input terminal for receiving a first signal;
a first output terminal coupled to the first input terminal for outputting a second signal based on the first signal;
a second output terminal for outputting a third signal;
a first throw;
a second throw;
a third throw; and
a pole selectively contacting with one of the first throw, the second throw, and the third throw, the first output terminal being enabled to output the second signal during a time interval when the pole contacts with none of the first throw, the second throw, and the third throw.

2. The three-state switch according to claim 1, wherein the first throw remains suspended, the second throw is coupled to a virtual ground point, the third throw is coupled to the second output terminal, and the pole is coupled to the first output terminal.

3. The three-state switch according to claim 1, wherein the first throw is coupled to a node that is coupled to the second output terminal.

4. The three-state switch according to claim 3, wherein the three-state switch comprises a second input terminal being coupled to the node.

5. The three-state switch according to claim 4, wherein the second throw is coupled between the first input terminal and the first output terminal.

6. The three-state switch according to claim 5, wherein the third throw remains suspended.

7. The three-state switch according to claim 6, wherein the pole is coupled to a virtual ground point.

8. A power supply circuit for supplying an operating voltage and a holding signal to a load, the power supply circuit comprising:
a direct current for outputting an initial voltage;
a regulator coupled to the direct current for receiving the initial voltage;
a three-state switch coupled to the direct current and the regulator, the three-state switch comprising:
a first input terminal coupled to the direct current;
a first output terminal coupled to the first input terminal and the regulator, for outputting; and
a second output terminal for outputting the holding signal; the three-state switch having a first state in which the first output terminal outputs a driving signal to have the regulator output the operating voltage and the second output terminal is disabled, and a second state in which the first output terminal outputs the driving signal to the regulator and the second output terminal outputs a holding signal to hold a present state of the load, during a switching procedure between the first state and the second state, the first output terminal keeps outputting the driving signal to the regulator.

9. The power supply circuit according to claim 8, wherein the three-state switch comprises a third state in which both the first output terminal and the second output terminal are disabled.

10. The power supply circuit according to claim 9, wherein the three-state switch comprises a pole and a first throw for contacting with the pole to set the three-state switch in the first state.

11. The power supply circuit according to claim 10, wherein the three-state switch comprises a second throw for contacting with the pole to set the three-state switch in the second state.

12. The power supply circuit according to claim 11, wherein the three-state switch comprises a third throw for contacting with the pole to set the three-state switch in the third state.

13. A three-state switch comprising:
a first input terminal for receiving a first signal;
a first output terminal;
a second output terminal;
wherein the three-state switch having a first state in which the first output terminal outputs a second signal based on the first signal and the second output terminal is disabled, and a second state in which the first output terminal outputs the second signal and the second output terminal outputs a third signal, during a switching procedure between the first state and the second state, the first output terminal keeps outputting the second signal.

14. The three-state switch according to claim 13, wherein the three-state switch comprises a third state in which the first output terminal and the second output terminal are both disabled.

15. The three-state switch according to claim 14, wherein the three-state switch comprises a pole and a first throw for contacting with the pole to set the three-state switch in the first state, a second throw for contacting with the pole to set the three-state switch in the second state, and a third throw for contacting with the pole to set the three-state switch in the third state.

16. The three-state switch according to claim 15, wherein the first throw remains suspended, the second throw is coupled to a virtual ground point, the third throw is coupled to the second output terminal, and the pole is coupled to the first output terminal.
